(19) United States
(12) Patent Application Publication
(10) Pub. No.: US 2010/0061730 A1
(43) Pub. Date: Mar. 11, 2010

(54) OPTICAL TRANSMITTING OR RECEIVING UNIT INTEGRATING A PLURALITY OF OPTICAL DEVICES EACH HAVING A SPECIFIC WAVELENGTH DIFFERENT FROM EACH OTHER

(75) Inventors: Morihiro SEKI, Yokohama-shi (JP); Kazushige OKI, Yokohama-shi (JP); Kengo MATSUMOTO, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/553,653

(22) Filed: Sep. 3, 2009

Related U.S. Application Data
(60) Provisional application No. 61/094,690, filed on Sep. 5, 2008.

(51) Int. Cl. H04J 14/02; H04B 10/04; H04B 10/06

(52) U.S. Cl. 398/79; 398/182; 398/202

(57) ABSTRACT

An optical unit is disclosed, in which the optical unit provides four optical devices each of which corresponds to a specific wavelength different from each other. In the transmitter unit, the unit includes two optical modules each including two optical devices and one filter unit with a polarization beam filter. The optical beam form two optical devices are combined by the polarization beam filter, while the optical output from the optical modules are combined with the thin film filter.

### CROSS-REFERENCE TO RELATED APPLICATION

This application claims priority to U.S. Provisional Patent Application Ser. No. 61/094,690, filed on Sep. 5, 2008, which is incorporated herein by reference in its entirety.

### BACKGROUND OF THE INVENTION

1. Field of the Invention

The present invention relates to an optical transmitting or receiving module, in particular, the invention relates to an optical module that integrates a plurality, typically four, of optical subassemblies.

2. Related Prior Art

The United States patent published as US 20060088255A has disclosed an optical module that includes four optical subassemblies each having a CAN package and four Wavelength-division-multiplexed (WDM) filter each made of multi-layered films. The optical module disclosed therein integrates these four subassemblies and four WDM filters with a metal block.

In the receiver optical module, the first WDM filter distinguishes the signal light with a wavelength λ1 from the other signal light of the wavelengths, λ2 to λ4, and the subsequent WDM filters similarly distinguishes only one signal light from the other light. Thus, the last signal light with the wavelength λ4 is cumulatively influenced with all WDM filters, which makes it hard to align the WDM filter and the optical subassembly, and, due to the slight bend of the WDM filter, the beam is tend to diverge.

### SUMMARY OF THE INVENTION

One aspect of the present invention relates to a transmitter optical unit that emits light with a plurality of specific wavelengths different from each other. The transmitter optical unit comprises: a plurality of transmitter optical modules, a WDM unit and a sleeve unit. Each of transmitter optical modules includes two transmitter optical devices and a polarization beam splitter. Each of transmitter optical devices emits light with one of the specific wavelengths and the beam splitter merges the light emitted from respective optical devices. The WDM unit multiplexes the merged light that is output from each of the transmitter optical modules. The sleeve unit outputs the multiplexed light.

In the present transmitter optical unit, a plurality of transmitter optical modules, two transmitter optical modules in the embodiment described below, are independently built with the WDM unit. Accordingly, the optical arrangement of the present invention may release the optical unit from a cumulative alignment error often occurred in the conventional optical module. Moreover, the transmitter optical module of the present invention has an arrangement of, what is called, a bi-directional module that provides two optical devices whose optical axes makes a right angle, one of which is in parallel to the optical axis of the module, which may realize a cost effective unit.

Another aspect of the invention relates to a receiver optical unit that receives light with a plurality of specific wavelengths different from each other. The receiver optical unit comprises, similar to the transmitter optical unit: a sleeve unit, a WDM unit and a plurality of receiver optical modules. The sleeve unit receives the light. The WDM unit de-multiplexes the received light, depending on the specific wavelengths, into a plurality of de-multiplexed light each having two of the specific wavelengths. Each of the receiver optical modules receives one of the de-multiplexed light and includes two receiver optical devices and a WDM filter. The WDM filter transmits a portion of the de-multiplexed light that has one of the specific wavelengths and reflects another portion of the de-multiplexed light that has the other of the specific wavelengths contained in the de-multiplexed light. One of the receiver optical devices receives the portion of the de-multiplexed light transmitter through the WDM filter; while, the other of the receiver optical devices receives the other portion of the de-multiplexed light reflected by the WDM filter.

In the present receiver optical unit, a plurality of receiver optical modules, two receiver optical modules in the embodiment described below, are independently built with the WDM unit. Accordingly, the optical arrangement of the present invention may release the receiver optical unit from a cumulative optical alignment error often occurred in the conventional optical module. Moreover, the receiver optical module of the present invention has an arrangement of, what is called, the bi-directional module that provides two optical devices whose optical axes makes the right angle, one of which is in parallel to the optical axis of the receiver optical module and the other of which is in perpendicular to the optical axis of the module, which may realize a cost effective unit.

### BRIEF DESCRIPTION OF DRAWINGS

The foregoing objects and advantages of the present invention may be more readily understood by one skilled in the art with reference being had to the following detailed description of several embodiments thereof, taken in conjunction with the accompanying drawings wherein like elements are designated by identical reference numerals throughout the several views, and in which:

FIG. 1 is a perspective view of a transmitter unit according to an embodiment of the present invention;

FIG. 2 schematically illustrates the optical arrangement of the transmitter unit shown in FIG. 1;

FIG. 3 is a cross sectional view of the optical module installed in the transmitter unit shown in FIG. 1;

FIG. 4 is a perspective view of the inner arrangement of the transmitter optical device which is built in the optical module shown in FIG. 3;

FIG. 5 schematically illustrates the optical arrangement of the receiver unit according to the second embodiment of the inventions;

FIG. 6A is a perspective view of the inner arrangement of the receiver optical device which is build in the receiver unit shown in FIG. 5, and FIG. 6B is a plan view of the inner arrangement of the receiver optical device; and

FIG. 7 is a cross section of the sleeve unit built in the transmitter unit shown in FIGS. 1 and 2, and built in the receiver unit shown in FIG. 5.

### DESCRIPTION OF EMBODIMENTS

The present invention is to provide an optical unit that integrates a plurality, typically four, of optical subassemblies each transmitting or receiving signal light with a wavelength different from each other, and realizes an easily processed optical alignment and expanded alignment tolerance.

### First Embodiment

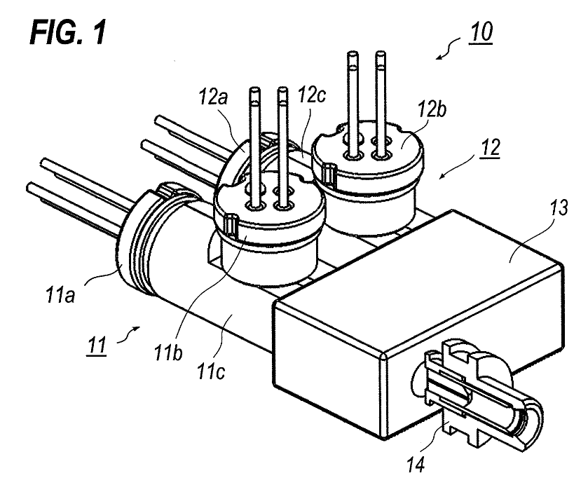

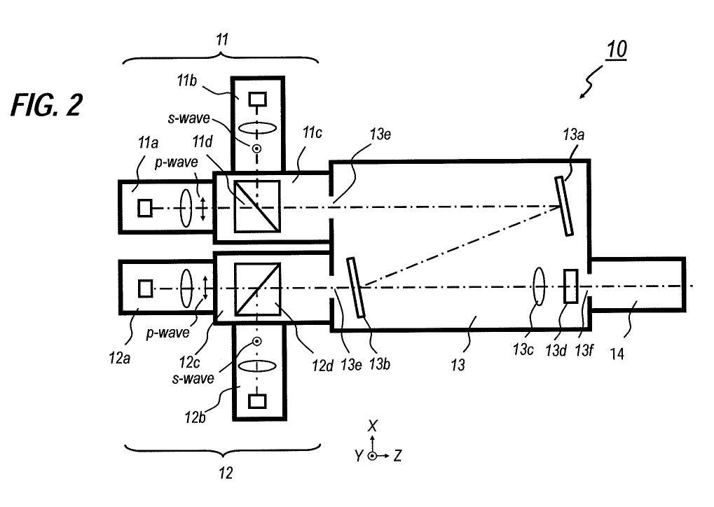

FIG. 1 illustrates an appearance of the unit according to the present invention, and FIG. 2 schematically illustrates an optical arrangement of a transmitting unit. First, the transmitting unit will be described.

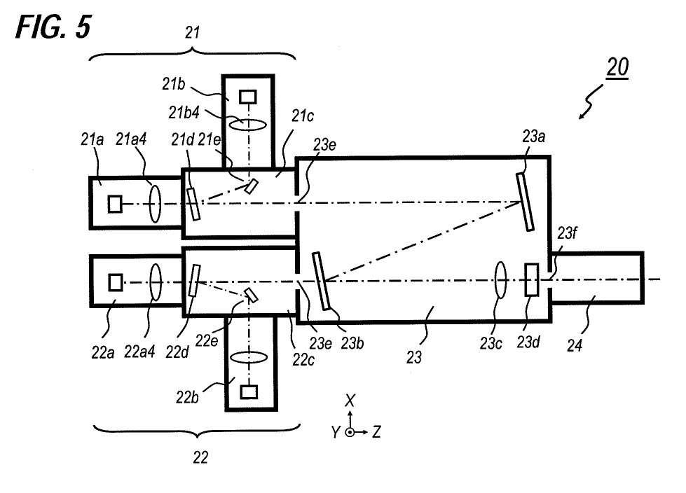

The transmitting unit 10 comprises two optical modules, 11 and 12, one WDM unit 13 and a sleeve assembly 14 assembled in a front end of the WDM unit 13. Each optical module, 11 or 12, includes two optical devices, in this case, the transmitter optical devices, 11a and 11b, or 12a and 12b, and one filter unit 11c, or 12c. The transmitter optical devices, 11a to 12b, provides a laser diode (LD) and a collimating lens installed within, what is called, a CAN package. The outer shape of the CAN package and an inner arrangement thereof are well known in the field. A typical arrangement within the CAN package of the transmitter optical device is shown in FIG. 5, which is described later.

The transmitter optical devices, 11a and 11b, or 12a and 12b, are assembled with the filter unit, 11c or 12c. As illustrate in FIG. 1, the first transmitter optical device, 11a or 12a is built with the end of the filter unit 11c or 12c, so as to keep the optical axis thereof in parallel with the optical axis of the sleeve assembly 14, while, the second transmitter optical device, 11a2 or 11b2, is built in a midway of the filter unit, 11c or 12c, so as to set the optical axis thereof in perpendicular to the axis of the sleeve assembly 14. A portion of the outer surface of the filter unit, 11c or 12c, is processed in flat so as to build the second transmitter optical device, 11b or 12b, thereon. Thus, the optical axes of the first and second transmitter optical devices intersect with each other. The outer shape of the first optical module, 11 or 12, is substantially identical with those of, what is called, a bi-directional optical subassembly. However, such a bi-directional subassembly provides a receiver optical subassembly (hereafter denoted as ROSA) in a position where the second transmitter optical device, 11b or 12b, is built. The present optical module, 11 or 12, builds the transmitter optical device including the LD instead of the ROSA.

Referring to FIG. 2 and describing the first optical module 11, the filter unit 11c includes a polarization beam splitter 11d. This beam splitter 11d passes the light output from the first transmitter optical device 11a; while, reflects the light from the second transmitter optical device 11b depending on the polarization of the light. Accordingly, the first transmitter optical device 11a is necessary to be set with the filter unit so as to align the polarization of the light output therefrom substantially included within a virtual plane defined by the optical axes of the first and second transmitter optical devices, which is called as the p-wave.

On the other hand, the second transmitter optical device 11b is necessary to be built with the filter unit so as to set the polarization plane of the light output therefrom substantially in perpendicular to the polarization plane of the first subassembly, which is called as the s-wave. Here, among two directions in parallel to the virtual plane defined by two optical axes of the first and second transmitter optical devices, we set the Z-direction in parallel to the optical axis, while the X-direction in perpendicular to the optical axis. We further set the Y-direction in perpendicular to the virtual plane. Thus, two transmitter optical devices, 11a and 11b, are built with the filter unit 11c such that the polarization of the first transmitter optical device 11a is along the X-direction, while, the polarization of the second transmitter optical device 11b is along the Y-direction. This optical arrangement effectively mergers two light each emitted from the first transmitter optical device 11a and the second transmitter optical device 11b.

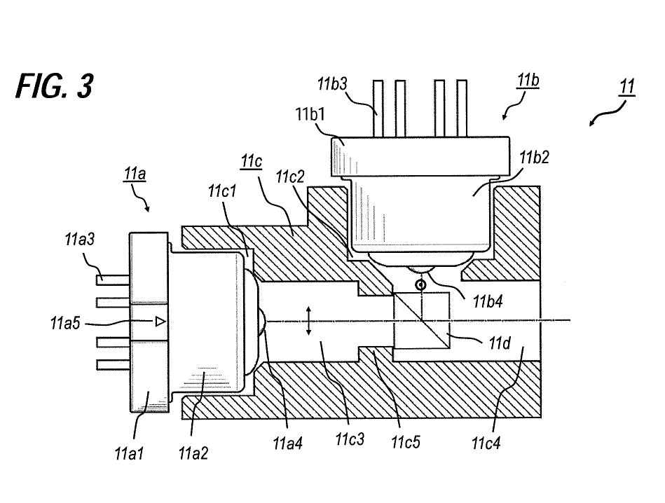

FIG. 3 is a cross section of the filter unit 11c and two transmitter optical devices, 11a and 11b, built with the filter unit 11c. The filter unit 11c provides several bores, 11c1 to 11c4. The first bore 11c1 receives the first transmitter optical device therein, while, the second bore 11c2 receives the second transmitter optical device 11b. These two bores have the inner diameter slightly greater than the outer diameter of the transmitter optical device, 11a or 11b; while, the depth of respective bores, 11c1 and 11c2, are larger than the height of the transmitter optical devices, 11a and 11b. Thus, two transmitter optical devices, 11a and 11b may be optically aligned in tree directions within ranges of the gap between the transmitter optical device, 11a or 11b, and the bore, 11c1 or 11c2. Because the transmitter optical devices, 11a and 11b, provide respective lenses, 11a4 and 11b4, in the top thereof, and the WDM unit 13 provides the other lens 13c, the alignment along respective optical axis for respective transmitter optical devices, 11a and 11b, that is, the adjustment of the transmitter optical devices, 11a and 11b, within the bores, 11c1 and 11c2, may be relatively dull.

Specifically, although the light emitted from the LD in the transmitter optical device, 11a or 11b, is dispersive, the lens, 11a4 or 11b4, in the top of the transmitter optical device, 11a or 11b, may convert this dispersive light into a substantially parallel beam. The other lens 13c may focus this substantially parallel beam onto the end of the optical fiber. Therefore, slight deviation along the optical axis of the transmitter optical device, 11a or 11b, within the bore, 11c1 or 11c2, may cause substantially no influence of the optical coupling.

On the other hand, the rotational alignment of the transmitter optical devices, 11a and 11b, to adjust the polarization thereof may cause the performance of the optical module 10 because the performance of the polarization beam filter is strongly depends on the polarization of the incident beam. The rotational alignment of the transmitter optical device, 11a or 11b, may be carried out by rotating the transmitter optical device, 11a or 11b, within respective bore, 11c1 or 11c2. Because the transmitter optical device, 11a or 11b, provides an alignment mark 11b5 in the outer surface thereof, while the outer surface of the filter unit 11c also provides the counter mark in the surface thereof, the rotational alignment of the transmitter optical devices, 11a and 11b, may be carried out to set the tip of the mark aligning with the tip of the counter mark in the filter unit 11c by rotating the transmitter optical devices, 11a and 11b, within respective bores, 11c1 and 11c2. The transmitter optical device, 11a or 11b, may be fixed within the bore, 11c1 or 11c2, by an adhesive.

The first bore 11c1 is connected to one of the center bore 11c3; while, the second bore 11c2 is connected to the other of the center bore 11c4. Between these two center bores, 11c3 and 11c4, is installed with the polarization filter lid as the filter 11d is fixed on the flange 11c5 to couple respective light coming from the transmitter optical devices, 11a and 11b.

The merged light output from the filter unit 11c enters the WDM unit 13 and is wholly reflected by the mirror to head the thin film filter (WDM filter) 13b. On the other hand, other merged light output from the other filter unit 12c also enters the WDM unit 13 but directly heads the WDM filter 13b. Assuming the wavelengths of the light coming from respective transmitter optical devices, 11a to 12b, to be λ1<λ2<λ3<λ4, the cut-off wavelength of the WDM filter 13b may be set between λ2 and λ3. That is, the WDM filter 13b fully reflects the light coming from the transmitter optical devices, 11a and 11b, while, the WDM filter 13b transmits the light coming from the other transmitter optical devices, 12a and 12b. Here, the relation between wavelengths of the light output from the first filter unit 11c may be λ2<λ1 and that from the second filter unit 12c may be λ4<λ3. In the latter case, the cut-off wavelength of the WDM filter may be set between λ1 and λ4. Moreover, the wavelength relation of respective light may be (λ3, λ4)<(λ1, λ2).

The WDM filter 13b may be made of multi-layered dielectric film. The materials, thicknesses, and the number of layers may vary characteristics of the WDM filter, in particular, the cut-off wavelength and the sharpness of the filtering may be varied by those parameters.

The light transmitting through or being reflected by the WDM filter 13b heads the sleeve assembly 14 and is focused on an end of the optical fiber set within the sleeve assembly 14 by the condensing lens 13c. The end of the sleeve assembly 14 exposes the edge of the optical fiber, and by condensing the light from the WDM filter 13 on this edge, the light including four optical signals emitted from the transmitter optical devices, 11a to 12b, may be transmitted in the optical fiber. Between the condensing lens 13c and the sleeve assembly 14 may be provided with an optical isolator 13d that prevents the light reflected at the edge of the optical fiber from returning the LDs to become an optical noise source.

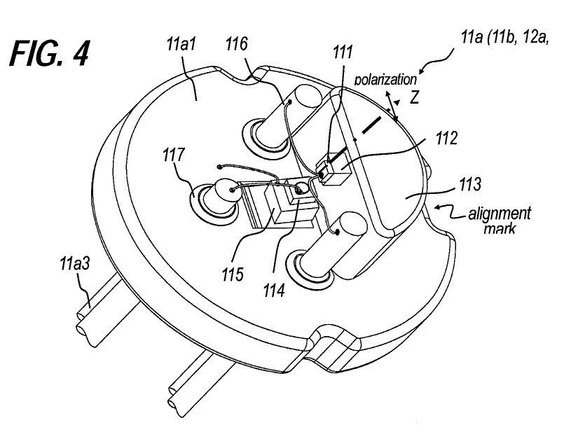

FIG. 4 is a perspective view of a typical example of the transmitter optical device, 11a or 11b. The optical device 11a comprises a stem 11a1 with a plurality of lead pins 11a3 and a cap 11a2 providing a lens 11a4 in the top center thereof. The stem 11a1 and the cap 11a2 may be made of metal, such as alloy of nickel and cobalt which is called as Kovar, and fixed with each other by the resistance welding. The stem mounts the semiconductor laser diode (hereafter denoted as LD) 11a on the side surface of the block 113 through the LD sub-mount 112. The block 113 protrudes from the primary surface of the stem 11a1 and may be made of also Kovar. The LD 111 may a type of the edge emitting LD that emits light along the primary surface thereof. This arrangement of the LD 111 mounted on the side surface of the block 113 may head the beam emitted from the LD 111 for the direction Z in perpendicular to the primary surface of the stem 11a1. This beam along the axis Z may be converted to the substantially parallel beam by the lens 11a4 provided in the top of the cap 11a2. The light emitted from the LD 111 has the polarization in parallel to the primary surface of the LD 111 when the LD 111 has the structure of the edge-emitting type. Accordingly, the light provided from the transmitter optical device shows the polarization as those shown in FIG. 4. Thus, the polarization vector of the transmitter optical device 11a may be identified by setting the alignment mark

The stem 11a1 also mounts a photodiode (hereafter denoted as PD) 114 placed beneath the LD 111 through the PD sub-mount 115. This PD monitors the light emitted from the back facet of the LD to maintain the magnitude of the optical beam output from the LD 111 in constant. The PD 114 with the PD sub-mount 115 is mounted on a surface slightly slanted to the primary surface of the stem 11a1. This arrangement may effectively prevent the light emitted from the LD 111 and reflected at the surface of the PD 114 from returning the LD 111. The LD 111 is driven by the driving signal provided through the lead pins, 11a3, and the bonding wires 116. While, the signal generated by the PD 114 by monitoring the back facet beam from the LD 111 may be output through the other lead pin 11a3. The lead pins 11a3 are electrically isolated from the stem 11a1 by, for instance, seal glass filled in a gap between the lead pin 11a3 and the stem 11a1.

The assembly of the transmitting unit 10 will be described. First, in advance to the alignment of the transmitter optical devices, 11a and 11b, the beam splitter 11d is set on the flange 11c5 within the center bore 11c4 of the filter unit 11c so as to align the direction thereof with the bores, 11c1 and 11c2. Epoxy resin may fix the beam splitter 11d on the flange 11c5. Next, two transmitter optical devices, 11a and 11b, are build with the filter unit 11c. The devices, 11a and 11b, may be aligned with the filter unit 11c by setting the optical power measured by a power meter temporarily placed in the end of the filter unit 11c becomes maximum as the alignment mark 11a5 in the stem, 11a1 or 11b1, aligns with the counter mark in the filter unit 11c. Fixing of the transmitter optical devices, 11a and 11b, with the filter unit 11c may be carried out by filling the gap between the cap, 11a2 or 11b2, and the bore, 11c1 or 11c2, with epoxy resin and congealing the resin. Another optical module 12 may be assembled by the same way.

The WDM unit 13 may be build with the sleeve unit 14 as follows: First, the thing file filter 13a, the mirror 13b, the condensing lens 13c and the isolator 13d are build in the WDM unit 13 and fixed in respective positions by epoxy resin, or by the YAG laser welding. Next, a test beam is practically provided from an external light source through the optical fiber in the sleeve unit 14. The sleeve unit 14 is aligned with the WDM unit 13 so as to maximize the optical power practically monitored at the entrance window 13e by sliding the sleeve unit 14 on the exit window 13f of the WMD unit 13. Finally, two optical modules, 11 and 12, are build with the WDM unit 13 such that, practically operating the transmitter optical device, 11a or 11b, the magnitude of the optical beam detected by the power monitor through the optical fiber in the sleeve unit 14 becomes maximum by sliding the optical module, 11 or 12, around the entrance window 11e of the WDM unit. The optical modules, 11 and 12 are fixed with the WDM unit 13 by the YAG laser welding. Thus, the transmitter unit 10 is completed.

### Second Embodiment

Next, the receiver unit 20 will be described as referring to FIG. 5.

The Rx unit 20 is necessary to divide signal light propagating in the optical fiber in the sleeve unit 24 into a plurality of optical beams each having a specific wavelength different from each other and to guide each beam to a corresponding receiver optical device, 21a to 22b. The polarization of the signal light transmitting in the optical fiber is not only unknown but unsteady. Even when the transmitter unit 10 explained above is applied, although the orthogonality of two beams, (λ1, λ2) and (λ3, λ4), each accompanied with respective filter units, 11c or 12c, may be maintained, but the absolute angle thereof is indefinite at the receiver unit 20. The transmission fiber is occasionally twisted; moreover, the polarization angle is often influenced by transmission conditions. Therefore, the receiver unit 20 is quite hard to apply the polarization beam splitter as those provided in the transmitter unit 10.

Referring to FIG. 5, the light provided from the transmission fiber in the sleeve unit 24 enters the WDM filter 23b after it is converted into a substantially parallel beam by the collimating lens 23c. The WDM filter 23b distinguishes the light that includes the wavelengths (λ1, λ2) from the light that includes the wavelengths (λ3, λ4). That is, the former light is substantially wholly reflected by the WDM filter 23b, while, the latter light in a substantially whole portion thereof transmits the WDM filter 23b. Or, in an opposite situation, the light with the wavelengths (λ3, λ4) is substantially reflected, while, the light with the wavelengths (λ1, λ2) transmits the WDM filter 23b. Explanations below assume a case where the light with wavelengths (λ1, λ2) is reflected, while the other light with the wavelengths (λ3, λ4) passes the WDM filter 23b.

The light with the wavelengths (λ1, λ2) reflected by the WDM filter 23b is reflected by the mirror 23a again and heads the first module 21. The first module 21 includes two receiver optical devices, 21a and 21b, and a filter unit 21c. The light from the WDM unit 23 first enters the filter unit 21c. As already explained, because the light shows an indefinite polarization, not only the filter unit 21c cannot apply the polarization beam splitter like the splitter, 11d or 12d, in the former embodiment, but, even when a thin film filter like the filter 13b also appeared in the former embodiment is applied thereto, the reflectivity and the transmittance of such thin film filter depend on the polarization of the incident beam and the incident angle. That is, the larger the incident angle, the larger the dependence of the polarization for the reflectivity and the transmittance. Therefore, the incident angle of the light to the thin film filter is necessary to be smaller than, for example, 10°.

However, such an optical arrangement restricts the configuration of the second receiver optical device, 21b or 22b, whose optical axis is in perpendicular to the axis of the sleeve unit 24. It is almost impossible to build the second receiver optical device, 21b or 22b, with the filter unit, 21c or 22c, so as to satisfy the incident angle of the light into the thin film filter in the filter unit, 21c or 22c. Therefore, the exemplary arrangement illustrated in FIG. 5 provides another mirror, 21e or 22e, which reflects the light from the thin film filter, 21d or 22d, again to the second receiver optical device, 21b or 22b, built with the filter unit, 21c or 22c, such that the optical axis of the second optical device, 21b or 22b, is in parallel to the X-direction.

Similar to the WDM filter 23b in the WDM unit 23, the light (λ3, λ4) entering the first receiver module 21 is divided into two beams, one of which accompanied with the wavelength λ3 passes the thin film filter 21d to enter the first receiver optical device, while, the other of which with the wavelength λ4 is reflected by the thin film filter 21d and heads the second receiver optical device 21b by being reflected again by the mirror 21e.

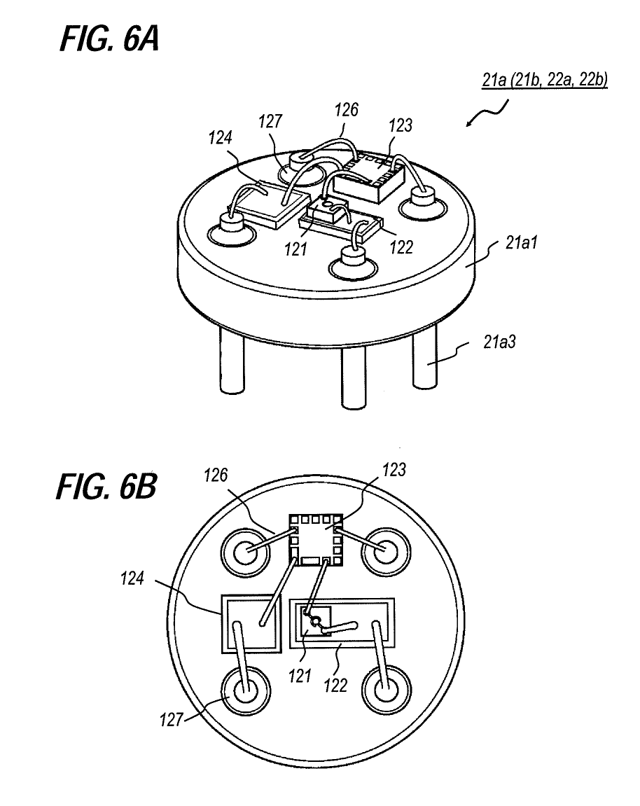

FIG. 6A is a perspective view of an inner arrangement of respective receiver devices, 21a to 22b, while, FIG. 6B is a plan view of the devices. The receiver optical device 21a also has a configuration of, what is called as the CAN package that primarily comprises of the stem 21a1 and the cap (not illustrated in figures). The cap provides a condenser lens 21a4 in the top portion thereof, while, the stem 21a1 protrudes a plurality of lead pins 21a3. The stem 21a1 mounts a PD 121 in a center portion on a primary surface thereof through a die capacitor 122. That is, the die capacitor 122 is mounted on the stem 21a1 as one of electrodes provided in the back surface thereof faces with and comes in directly contact with the primary surface of the stem 21a1; while, the other electrode thereof in the top surface thereof mounts the PD 121 thereof. The die capacitor 122 may operate as a bypassing capacitor provided in the bias supplying line for the PD 121.

The stem also mounts the pre-amplifier 123. The pre-amplifier 123 receives a faint signal generated by the PD 121 as it receives the optical signal externally provided through the condenser lens on the top of the cap, amplifies this signal and outputs it through the other lead pins 21a3 in the form of the differential signal. Another die capacitor 124 is provided on the primary surface of the stem 21a1 to bypass the power supply line for the pre-amplifier 123. Bonding wires may connect elements mounted on the stem 21a1.

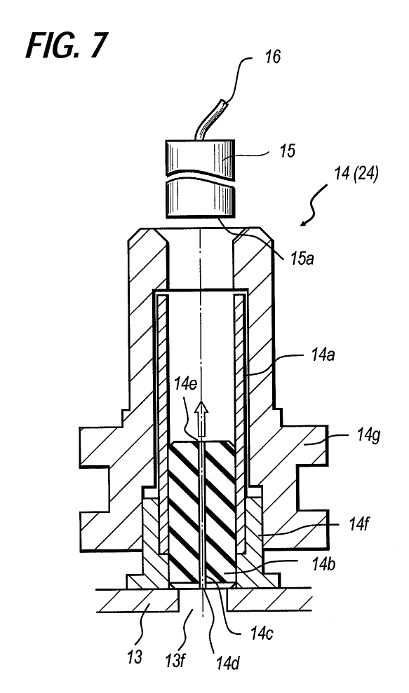

Finally, the sleeve unit, 14 or 24, will be described. FIG. 7 illustrates an example of the sleeve unit 14 in a sectional form. The sleeve unit 14 primarily comprises of a sleeve 14a, a stub 14b, a bush 14f and a cover 14g. The sleeve, which may be made of ceramics such as zirconia, plastics and metal, may be a rigid sleeve and a split sleeve. The stub 14b provides a coupling fiber 14c in a center thereof. The stub 14b is press-fitted within a root portion of the sleeve 14a. The bush 14f, which may be made of metal, presses a root portion of the sleeve 14a by being pressed by the cover. That is, the bush 14f is press-fitted into a gap between the sleeve 14a and the cover 14g to caulk the gap, which reliably abut the sleeve 14a against the stub 14c. The bush 14f provides a flange portion in the end thereof. This flange portion is fixed on the WDM unit 13 by YAG laser welding after it is optical aligned with the WDM unit 13.

The light coming from the WDM unit 13 may be focused on the end 14d of the coupling fiber by the condenser lens 13c in the WDM unit 13. On the other hand, the external ferrule 15 that provides the external fiber 16 in a center thereof comes in physically contact with the other end 14e of the coupling fiber 14c. Although not explicitly illustrated, this end of the stub 14b is formed in convex with the tip of the coupling fiber 14c, while, the end of the external ferrule 15 also has a convex end shape. Thus, by inserting the ferrule 15 into the sleeve 14a and abutting the tip end thereof against the stub 14b, the physical contact between the coupling fiber 14c and the external fiber 16 may be realized, which may effectively reduce the Fresnel reflection at the interface.

A method to build the receiver optical unit 20 is described below. First, the thin film filter 23b and the mirror 23a is pre-assembled in the WDM unit 23 with, for instance, epoxy resin and the sleeve unit 24 is fixed to the WDM unit 23 by epoxy resin or YAG laser welding. Second, two receiver optical devices, 21a and 21b, or 22a and 22b, are built with respective filter units, 21c and 22c, such that, temporarily setting a light source at the exit port of the module, 21 or 22, and practically activating the light source, the respective optical devices, 21a to 22b, are aligned and fixed so as to maximize the signal output from the optical devices. In this process, the rotation of the optical devices, 21a to 22b, within respective bores are unconcerned. Epoxy resin with ultraviolet curable resin may fix the optical devices, 21a to 22b, with the filter units, 21c and 22c. Finally, temporarily connecting an optical fiber in the sleeve unit 24, where the optical fiber accompanies with a light source, and practically operating the light source, the optical modules each assembled the filter unit, 21c or 22c, with the optical devices, 21a and 21b, or 22a and 22b, are aligned at the port 23e such that the signal output from the optical devices, 21a and 22a, which have the optical axis in parallel to the axis of the sleeve unit 24, becomes maximam.

Thus, the present invention provides the transmitter unit 10 or the receiver unit 20, each including two optical modules, 11 and 21, or 21 and 22, accompanied with two optical devices, 11a and 11b, 12a and 12b, 21a and 21b, or 22a and 22b. Respective optical modules, 11 and 12, or 21 and 22, may be built with the WDM unit, 13 or 23, after each module pre-assembles two optical devices and optically aligns them with the filter unit independently. Thus, the alignment tolerance of respective optical devices may be relaxed.

What is claimed is:

1. A transmitter optical unit that emits light with a plurality of specific wavelengths different from each other, comprising:
a plurality of transmitter optical modules that includes two transmitter optical devices and a polarization beam splitter, said
transmitter optical devices each emitting light with one of said plurality of said specific wavelengths, said polarization beam splitter merging said light emitted from said transmitter optical devices;
a WDM unit for multiplexing said merged light output from said plurality of transmitter optical modules; and
a sleeve unit for outputting said multiplexed light.

2. The transmitter optical unit of claim 1,
wherein said transmitter optical devices have respective optical axes substantially perpendicular to each other, one of said optical axes being in parallel to an optical axis of said transmitter optical module.

3. The transmitter optical unit of claim 1,
wherein said transmitter optical unit includes two transmitter optical modules, and
wherein said multiplexed light includes four specific wavelengths.

4. The transmitter optical unit of claim 3,
wherein said WDM unit includes a WDM filter and a mirror, said mirror reflecting one of said merged light emitted from said one of said two of said transmitter optical modules to said WDM filter, said WDM filter transmitting other of said merged light emitted from said other of said tow of said transmitter optical modules and reflecting said one of said merged light reflected by said mirror.

5. The transmitter optical unit of claim 3,
wherein said specific wavelengths of said merged light emitted from said one of said transmitter optical modules are smaller than said specific wavelengths of said merged light emitted from said other of said transmitter optical modules.

6. The transmitter optical unit of claim 3,
wherein said specific wavelengths of said merged light emitted from said one of said transmitter optical modules are greater than said specific wavelengths of said merged light emitted from said other of said transmitter optical modules.

7. The transmitter optical unit of claim 1,
wherein said transmitter optical devices have a CAN package.

8. A receiver optical unit that receives light with a plurality of specific wavelengths different from each other, comprising:
a sleeve unit for receiving said light;
a WDM unit for de-multiplexing light that is output from said sleeve unit into a plurality of de-multiplexed light each having two of said specific wavelengths; and
a plurality of receiver optical modules each receiving one of said de-multiplexed light, said receiver optical module including two receiver optical devices and a WDM filter, said WDM filter transmitting a portion of said de-multiplexed light having one of said specific wavelengths and reflecting another portion of said de-multiplexed light having other of said specific wavelengths, one of said receiver optical devices receiving said portion of light transmitted through said WDM filter and other of said receiver optical devices receiving said other portion of said light reflected by said WDM filter.

9. The receiver optical unit of claim 8,
wherein said receiver optical devices have respective optical axes substantially perpendicular to each other, one of said optical axes being in parallel to an optical axis of said receiver optical module.

10. The receiver optical unit of claim 9,
wherein said receiver optical device further includes a mirror for reflecting said other portion of light that is reflected by said WDM filter for said other of said receiver optical devices, and
wherein said optical axis of said one of said receiver optical devices is in parallel to said optical axis of said receiver optical module and said optical axis of said other of said receiver optical devices is in perpendicular to said optical axis of said receiver optical module.

11. The receiver optical unit of claim 8,
wherein said receiver optical unit includes two receiver optical modules, and
wherein said light received by said receiver optical unit has four specific wavelengths.

12. The receiver optical unit of claim 11,
wherein said WDM unit includes a WDM filter and a mirror, said WDM filter reflecting a portion of said light and transmitting another portion of said light both received by said receiver optical unit, said mirror reflecting said other portion of said light reflected by said WDM filter.

13. The receiver optical unit of claim 11,
wherein said specific wavelengths of said de-multiplexed light reflected by said mirror in said WDM unit are smaller than said specific wavelengths of said de-multiplexed light transmitted through said WDM filter in said WDM unit.

14. The transmitter optical unit of claim 11,
wherein said specific wavelengths of said de-multiplexed light reflected by said mirror in said WDM unit are greater than said specific wavelengths of said de-multiplexed light transmitted through said WDM filter in said WDM unit.

15. The transmitter optical unit of claim 8,
wherein said receiver optical devices each have a CAN package.
